(19) United States
(12) Patent Application Publication
(10) Pub. No.: US 2007/0134028 A1
(43) Pub. Date: Jun. 14, 2007

(54) Image forming apparatus

(75) Inventor: Eiji Funabashi, Yokohama (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/634,167

(22) Filed: Dec. 6, 2006

(30) Foreign Application Priority Data
Dec. 14, 2005 (JP) 10-2005-0360087
Feb. 10, 2006 (KR) 10-2006-0012888

(51) Int. Cl. G03G 15/01; G03G 15/16

(52) U.S. Cl. 399/299; 399/313

(57) ABSTRACT

An image forming apparatus such as a tandem type color image forming apparatus is provided. The image forming apparatus includes a transfer belt that rotates in a rotating direction in which a toner image is transferred. A plurality of color latent image carrying members are arranged successively along the rotating direction so as to form various color toner images, and a monochrome latent image carrying member is located at any one end of the color latent image carrying members so as to form a monochrome toner image. A plurality of color transfer rollers and a monochrome transfer roller are arranged opposite to the color image carrying members and the monochrome image carrying member, respectively, with the transfer belt therebetween. A roller supporting member supports all of the color transfer rollers. A roller shifting unit moves the roller supporting member in a direction in which the color transfer rollers move toward or away from the color latent image carrying members. The diameters of the color transfer rollers are smaller than the diameter of the monochrome transfer roller. The color transfer rollers press against the color image carrying members with an appropriate force so that hollow defects are prevented.

### CROSS-REFERENCE TO RELATED PATENT APPLICATIONS

This application claims the benefit under 35 U.S.C. § 119(a) of Japanese Patent Application No. 10-2005-0360087, filed on Dec. 14, 2005, in the Japanese Intellectual Property Office, and Korean Patent Application No. 10-2006-0012888, filed on Feb. 10, 2006, in the Korean Intellectual Property Office, the entire disclosures of which are hereby incorporated by reference.

### BACKGROUND OF THE INVENTION

1. Field of the Invention

The present invention relates to an electrophotographic image forming apparatus used in applications such as copying machines and printers. More particularly, the present invention relates to a tandem type color image forming apparatus using an improved transfer belt.

2. Description of the Related Art

Among conventional types of electrophotographic image forming apparatus, a tandem type image forming apparatus includes a plurality of latent image carrying members such as photosensitive drums and a transfer belt. A toner image is formed on each of the plurality of latent image carrying members, and the toner images are transferred from the latent image carrying members to the transfer belt. A monochrome latent image carrying member transfers a single (typically, black) color toner image to the transfer belt. Color latent image carrying members transfer colored toner images to the transfer belt. Transfer rollers are located opposite to the latent image carrying members, and the transfer belt is located between the rollers and the latent image carrying members. The transfer rollers press the transfer belt toward the latent image carrying members to transfer toner images from the latent image carrying members to the transfer belt. In a mono-color printing mode, in which a single color toner image is transferred to the transfer belt, if both the monochrome color latent image carrying member and the plurality of the color latent image carrying members are pressed by the transfer rollers, the color latent image carrying members can deteriorate even though they are not used. To prevent this, a conventional image forming apparatus moves the color latent image carrying members away from the transfer belt in a mono-color printing mode. Japanese Patent Publication No. 2003-337454 discloses one such conventional apparatus, and is hereby incorporated by reference in its entirety. In another type of conventional image forming apparatus, the transfer rollers are temporarily released from pressing against the color latent image carrying members. Japanese Patent Publication No. 2001-242680 discloses an example of this type of apparatus, and is hereby incorporated by reference in its entirety.

In a conventional image forming apparatus, however, it is difficult to make the apparatus compact because of the mechanisms required to move the color latent image carrying members toward the transfer belt are complicated. FIG. 7 shows an image forming apparatus 100 with a relatively compact structure for moving transfer rollers 103 toward image carrying members 103. The image forming apparatus has a transfer belt 104, which is supported by rotating rollers 108. A monochrome transfer roller 107 presses against the monochrome image carrying member 106 to transfer images to the transfer belt. A plurality of color image carrying members 102 have a plurality of corresponding transfer rollers 103. The transfer rollers 103 are supported by a pivot supporting plate 101. The pivot supporting plate 101 pivots about a supporting shaft 105, and pivots to press all of the color latent image carrying members 102 together against the image carrying members 102. With this type of image forming apparatus, the transfer rollers 103 are pressed against the transfer belt 104 so strongly that the toner image is transferred improperly, and image defects, such as, hollow defects, may be caused.

Accordingly, there is a need for an improved mechanism for moving a transfer roller toward a transfer belt.

### SUMMARY OF THE INVENTION

An aspect of the present invention is to address at least the above problems and/or disadvantages and to provide at least the advantages described below. Accordingly, an aspect of the present invention is to provide an image forming apparatus, in which the transfer roller is not strongly pressed to the transfer belt, in order to obtain high quality of transferred image and remove hollow defects.

According to an aspect of the present invention, an image forming apparatus includes a transfer belt that rotates in a rotating direction in which a toner image is transferred. A plurality of color latent image carrying members are arranged successively along the rotating direction so as to form various color toner images, and a monochrome latent image carrying member is located at any one end of the color latent image carrying members so as to form a monochrome toner image. A plurality of color transfer rollers and a monochrome transfer roller are arranged opposite to the color image carrying members and the monochrome image carrying member, respectively, with the transfer belt therebetween. A roller supporting member supports all of the color transfer rollers. A roller shifting unit moves the roller supporting member in a direction in which the color transfer rollers move toward or away from the color latent image carrying members. The diameters of the color transfer rollers are smaller than the diameter of the monochrome transfer roller.

One of an upstream or downstream end of the roller supporting member located may be pivotally supported by a fixing shaft.

The diameters of the color transfer rollers may become smaller as the color transfer rollers become more distant from the fixing unit.

The roller shifting unit may include a resilient biased member for biasing the roller supporting member to be spaced from the color latent image carrying members, and a shifting member for moving the roller supporting member to be closed to the color latent image carrying members while bearing against the force of the resilient biased member.

The shifting member may be a cam which contacts the roller supporting member. The cam may have an outer peripheral edge in which the distance from a rotating shaft of the cam varies.

The plurality of color transfer rollers may be attached to the roller supporting member through adjusting springs.

According to another aspect of the present invention, an image forming apparatus includes a transfer belt for receiving toner images. A plurality of color latent image carrying members for forming color toner images are arranged successively along the transfer belt. A monochrome latent image carrying member for forming monochrome toner images is located at one end of the plurality of color latent image carrying members. A monochrome transfer roller is arranged opposite to the monochrome image carrying member, and the transfer belt passes between the monochrome transfer roller and the monochrome image carrying member. A plurality of color transfer rollers are arranged opposite to the plurality of color image carrying members, and the transfer belt passes between the plurality of color transfer rollers and the plurality of color image carrying members. The diameters of the color transfer rollers are smaller than the diameter of the monochrome transfer roller. A roller supporting member supports the plurality of color transfer rollers, and a roller shifting unit moves the roller supporting member in a direction in which the color transfer rollers move toward or away from the color latent image carrying members.

A fixing shaft for pivotally supporting one end of the roller supporting member may be provided.

The diameters of the color transfer rollers may be substantially equal.

The diameters of the color transfer rollers may be different.

The diameters of the color transfer rollers may become smaller as the color transfer rollers become more distant from the fixing shaft.

The roller shifting unit may comprise a resilient biased member for biasing the roller supporting member away from the color latent image carrying members, and a shifting member for moving the roller supporting member towards the color latent image carrying members.

The shifting member may be a cam which contacts the roller supporting member.

The plurality of color transfer rollers may be attached to the roller supporting member by adjusting springs.

According to another aspect of the present invention, an image forming apparatus includes a transfer belt for receiving toner images. A plurality of color latent image carrying members for forming color toner images are arranged successively along the transfer belt. A monochrome latent image carrying member for forming monochrome toner images is located at one end of the plurality of color latent image carrying members. A monochrome transfer roller is arranged opposite to the monochrome image carrying member, and the transfer belt passes between the monochrome transfer roller and the monochrome image carrying member. A plurality of color transfer rollers are arranged opposite to the plurality of color image carrying members, and the transfer belt passes between the plurality of color transfer rollers and the plurality of color image carrying members. The diameters of the color transfer rollers are smaller than the diameter of the monochrome transfer roller. Means for supporting the plurality of color transfer rollers, and means for moving the means for supporting the color transfer rollers toward or away from the color latent image carrying members are provided.

The means for supporting the plurality of color transfer rollers may comprise a pivotable plate member.

The diameters of the color transfer rollers may become smaller as the color transfer rollers become more distant from a pivoting axis of the pivotable plate member.

The moving means may comprise a cam that contacts the pivotable plate member.

The image forming apparatus may further comprise means for biasing the pivotable plate member away from the color latent image carrying members.

The diameters of the color transfer rollers may be substantially equal.

The diameters of the color transfer rollers may be different.

According to another aspect of the present invention, an apparatus for adjusting a transfer roller in an image forming apparatus having a monochrome latent image carrying member and a monochrome transfer roller arranged opposite to the monochrome image carrying member and at least one color latent image carrying member and at least one color transfer roller arranged opposite to the color latent image carrying member comprises a roller supporting member supporting the at least one color transfer roller and a roller shifting unit to move the roller supporting member toward or away from the color latent image carrying member. The color transfer roller has a smaller diameter than the monochrome transfer roller.

The roller supporting member may be pivotally supported by a fixing shaft.

The apparatus may include a plurality of color latent image carrying members and a plurality of corresponding color transfer rollers disposed on the roller supporting member.

The diameters of the plurality of color transfer rollers may be substantially equal.

The diameters of the plurality of color transfer rollers may be different.

The roller shifting unit may comprise a resilient member for biasing the roller supporting member away from the color latent image carrying members and a shifting member for moving the roller supporting member closer to the color latent image carrying members against the force of the resilient member.

The shifting member may be a cam which contacts the roller supporting member.

According to another aspect of the present invention, an image forming apparatus is provided. The image forming apparatus includes a first latent image carrying member, a first transfer roller disposed opposite to the first image carrying member, a second latent image carrying member, and a second transfer roller disposed opposite to the second latent image carrying member. The second transfer roller has a smaller diameter than the first transfer roller. A means for moving the second transfer roller toward or away from the second latent image carrying member is provided.

The means for moving the second transfer roller may comprise a pivotable roller supporting member that supports the second transfer roller and a roller shifting unit to move the roller supporting member toward or away from the second latent image carrying member.

The image forming apparatus may also include a third latent image carrying member and a third transfer roller disposed opposite to the third latent image carrying member. The third transfer roller is supported by the pivotable roller supporting member.

The diameter of the third transfer roller may be the same as the diameter of the second transfer roller.

The diameter of the third transfer roller may be different than the diameter the second transfer roller.

The roller shifting unit may comprise a resilient member for biasing the roller supporting member away from the color latent image carrying members and a shifting member for moving the roller supporting member closer to the color latent image carrying members against the force of the resilient member.

The shifting member may be a cam which contacts the roller supporting member.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of an image forming apparatus according to an exemplary embodiment of the present invention;

FIG. 2 is a perspective view of a roller supporting unit and color transfer rollers of FIG. 1;

FIG. 3 is a side view of an image forming apparatus according to an exemplary embodiment of the present invention;

FIG. 4 is an enlarged side view of transfer rollers of FIG. 3;

FIG. 5 is a side view of an image forming apparatus according to another exemplary embodiment of the present invention;

FIG. 6 is an enlarged side view of transfer rollers of FIG. 5 and

FIG. 7 is a side view of a conventional image forming apparatus.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

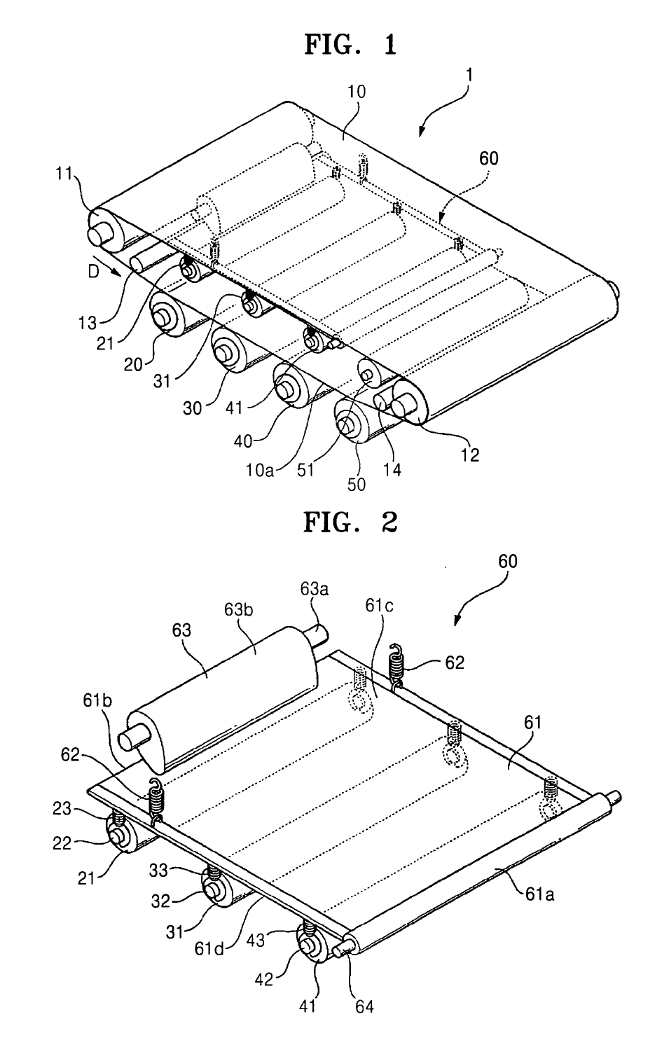

FIG. 1 is a perspective view of an image forming apparatus 1 according to an exemplary embodiment of the present invention. The image forming apparatus 1 comprises a transfer belt 10 onto which a toner image is transferred while rotating in a rotating direction D, a plurality of latent image carrying members 20, 30, 40 and 50 arranged successively in the direction D to contact an outer peripheral face (transfer face) 10a of the transfer belt 10, a plurality of transfer rollers 21, 31, 41 and 51 arranged opposite to the latent image carrying members 20, 30, 40 and 50 with transfer belt 10 therebetween, and a roller supporting unit 60 supporting color transfer rollers 21, 31, and 41.

As shown in FIG. 1, the transfer belt 10 is an endless loop which is supported by two main rotating rollers 11 and 12. The transfer belt 10 rotates in the rotating direction D when the rotating rollers 11 and 12 rotate simultaneously. The transfer belt 10 runs on the latent image carrying members 20, 30, 40 and 50 according to the direction D. A transfer face 10a is provided on the outer peripheral face of the transfer belt 10, and the toner images formed at the latent image carrying members 20, 30, 40 and 50 are transferred onto the transfer face 10a. The transferred toner image on the outer peripheral face 10a is either transferred to another transfer roller (not illustrated) that contacts the outer face or is transferred directly to a recording media. Tension supporting rollers 13 and 14 are provided on the same side of the transfer belt as the latent image carrying members. The tension supporting rollers 13 and 14 supply tension to the transfer belt 10 so that they properly contact the latent image carrying members. The latent image carrying members are divided into two groups. A first group comprises 3 color latent image carrying members 20, 30 and 40 to form colored toner images. The second group comprises a mono-color, i.e. black, latent carrying member 50 to form a monochrome toner image. The latent image carrying members 20, 30, 40 and 50 may be photosensitive drums. Toner images are formed on the outer peripheral faces of the drums.

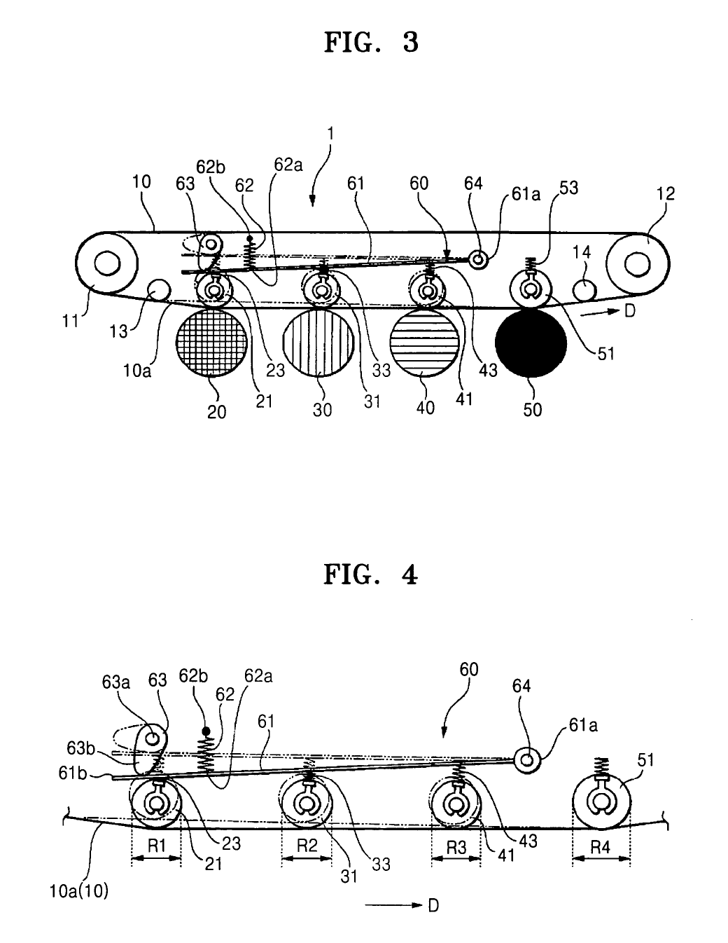

The three color latent image carrying members 20, 30 and 40 are successively arranged according to the rotating direction D. From the upstream area of the direction D, the first color image carrying member 20 forms a yellow color toner image. The second color image carrying member 30 forms a magenta toner image and the third color image carrying member 40 forms a cyan toner image. Also, at the downstream area of the rotating direction D, one monochrome latent image carrying member 50 is located parallel to the image carrying members 20, 30 and 40. The monochrome latent image carrying member 50 forms a black toner image. The latent image carrying members 20, 30, 40 and 50 are rotated by a motor according to the rotating direction D of the transfer belt 10. The color transfer rollers 21, 31 and 41 are arranged opposite to the latent image carrying members 20, 30 and 40 with the transfer belt 10 therebetween and the monochrome transfer roller 51 is arranged opposite to the latent image carrying member 50 with the transfer belt 10 therebetween. The monochrome transfer roller 51 is attached to a frame (not shown in FIG. 3) by a spring 53.

As shown in FIG. 3, the color transfer rollers 21, 31 and 41 and the monochrome transfer roller 51 are arranged inside the transfer belt 10. The axes of the monochrome transfer roller 51 and the latent image carrying members 20, 30, 40 and 50 are substantially parallel to one another. The transfer rollers 21, 31, 41 and 51 are following rollers (that is, they are rotated by the rotation of the latent image carrying members 20, 30, 40 and 50 and the transfer belt 10). The color transfer rollers 21, 31 and 41 are supported together by a roller supporting unit 60 (which is described in more detail later), and they are pressed to the color latent image carrying members 20, 30 and 40 by changing the location of the roller supporting unit 60. The monochrome transfer roller 51 is supported by a transfer roller supporter (not shown) and is always pressed to the monochrome latent image carrying member 50.

The roller supporting unit 60 which supports the color transfer rollers 21, 31 and 41 will now be described in detail. As shown in FIG. 2, the roller supporting unit 60 is arranged inside the transfer belt 10 and opposite to the color latent image carrying members 20, 30 and 40. The roller supporting unit 60 includes a roller supporting plate (roller supporting member) 61 for supporting all of the color transfer rollers 21, 31 and 41 to move toward or away from the color latent image carrying members 20, 30 and 40, a resilient tension spring (resilient biased member) 62 biased in the direction which the roller supporting plate 61 moves away from the color latent image carrying members 20, 30 and 40, and a cam (shifting member) 63 for pressing the roller supporting plate 61 to move toward the color latent image carrying member 20, 30 and 40 while bearing against a biased force of the resilient biased spring 62. A roller shifting unit includes the resilient biased spring 62 that biases the roller supporting plate 61 and the cam 63 that moves the plate toward the color latent image carrying members 20, 30 and 40 against the force of the resilient biased spring 62.

A first end 61a of the roller supporting plate 61 pivots about a fixing shaft 64. The fixing shaft 64 has an axis substantially perpendicular to the rotating direction D of the transfer belt 10. The roller supporting plate 61 is pivoted about the fixing shaft 64 and moves within a limited rotational range. The fixing shaft 64 is attached to a frame (not shown) of the image forming apparatus.

As shown in FIG. 2, the roller supporting plate 61 may be a thin plate. The first end 62a of the resilient biased spring 62 is attached on the upper face 61c of the plate 61 at a location near the second end 61b of the plate 61, which is disposed at the upstream area of the rotating direction D for the transfer belt 10 opposite to the other (first) end 61a supported at the fixing shaft 64 (refer to FIG. 3). The second end 62b of the spring 62 is fixed to a frame (not shown). The roller supporting plate 61 is biased away from the color latent image carrying members 20, 30 and 40 (in an upward direction in FIG. 3).

The cam 63 contacts the upper face 61c of the plate 61. A rotating shaft 63a of the cam 63 extends substantially parallel to the fixing shaft 64. The rotating shaft is offset eccentrically with respect to a cam body 63b, as shown in FIGS. 2 and 3. The cam 63 rotates according to the rotation of the rotating shaft 63a. The distance from the outer peripheral edge of the cam 63 to the rotating shaft 63a varies. As shown in double-dotted lines in FIGS. 3 and 4, while rotating the rotating shaft 63a, the outer peripheral edge of the cam 63 contacts the upper face 61c of the roller supporting plate 61 so that the location of the roller supporting plate 61 can be changed.

In the roller supporting unit 60, as shown in double-dotted lines in FIG. 3, when the outer peripheral edge nearest to the rotating shaft 63a contacts the upper face 61c of the roller supporting plate 61, the roller supporting plate 61 moves away from the color latent image carrying members 20, 30 and 40. In contrast, as shown in solid lines in FIG. 3, when the outer peripheral edge farthest from the rotating shaft 63a contacts the upper face 61c of the roller supporting plate 61, the roller supporting plate 61 moves toward the color latent image carrying members 20, 30 and 40.

The color transfer rollers 21, 31 and 41 are located under the lower face 61d of the roller supporting plate 61 and rotatably attached to adjusting springs 23, 33 and 43, respectively. The color transfer rollers 21, 31 and 41 have rotating shafts 22, 32 and 42 that are substantially parallel to the fixing shaft 64. Also, the axes of rotating shafts 22, 32 and 42 are substantially parallel to the axes of color latent image carrying members 20, 30 and 40. As shown in FIG. 4, the diameters R1, R2 and R3 of the color transfer rollers 21, 31 and 41 are smaller than the diameter R4 of monochrome transfer roller 51. This configuration differs from the conventional art, where the diameters R1, R2, and R3 of the color transfer rollers 103 are the same as the diameter R4 of the monochrome transfer roller 107.

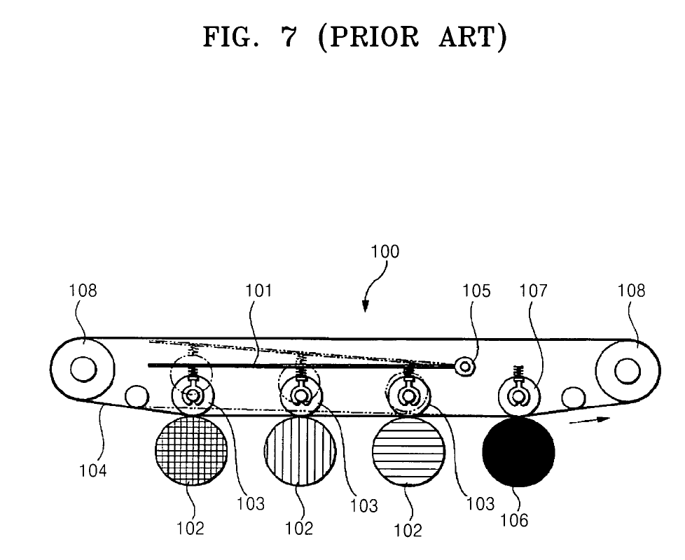

The image forming apparatus 1 as described above operates as follows. In the image forming apparatus 1, as shown in FIGS. 3 and 4, since the diameters R1, R2 and R3 of each color transfer rollers 21, 31 and 41 are smaller than the diameter R4 of the monochrome transfer roller 51, there is a large stroke between the color transfer rollers 21, 31 and 41 and the color latent image carrying members 20, 30 and 40, as compared to the conventional image forming apparatus 100 shown in FIG. 7.

As indicated in FIG. 4, when the cam 63 is shifted from the location indicated by double-dotted lines into the location indicated by solid lines (against the force of the resilient biased spring 62), the distance that the end 61b of the roller supporting plate 61 moves is large, and the roller supporting plate 61 can press the transfer rollers 21, 31 and 41 to the transfer belt 10 with an adequate pressure so that a desired image can be formed without the hollow defects that sometimes occur in the conventional art. Also, the pivot angle required to space the color transfer rollers 21, 31 and 41 from the transfer belt 10 is small as compared to the conventional art as shown in FIG. 7 so that the image forming apparatus can be made more compact.

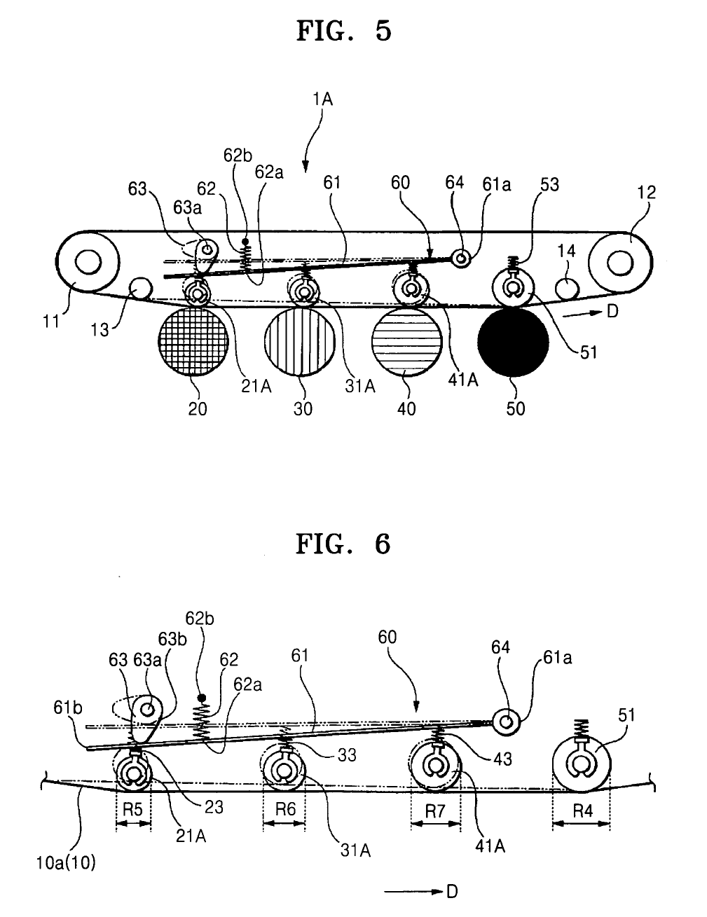

FIGS. 5 and 6 illustrate another exemplary embodiment of an image forming apparatus. FIG. 5 is a side view of an image forming apparatus according to another exemplary embodiment of the present invention and FIG. 6 is a side view of enlarged transfer rollers of FIG. 5. The same reference numerals are used for the same elements, features, and structures in the exemplary embodiment described above, and an explanation of these features is not repeated for conciseness.

In an image forming apparatus 1A according to the exemplary embodiment shown in FIGS. 5 and 6, the diameters R5, R6 and R7 of the color transfer rollers 21A, 31A and 41A become smaller as the color transfer rollers 21A, 31A and 41A become more distant from the fixing shaft 64. In detail, the diameter R7 of the color transfer roller 41A opposed to the color latent image carrying member 40 is smaller than the diameter R4 of the monochrome transfer roller 51. The diameter R6 of the color transfer roller 31A opposed to the color latent image carrying member 30 is smaller than the diameter R7 of the color transfer roller 41A. The diameter R5 of the color transfer roller 20 opposed to the color latent image carrying member 20 is smaller than the diameter R6 of the color transfer roller 31A. In other words, the diameter R5 of the color transfer roller 21A located farthest from the fixing shaft 64 is the smallest, the diameter R6 of the color transfer roller 31A is in the middle, and the diameter R7 of the color transfer roller 41A is the largest, but they are all smaller than the diameter R4 of the monochrome transfer roller 51. In this image forming apparatus 1 of the exemplary embodiment, the diameters R5, R6 and R7 of color transfer rollers 21A, 31A and 41A are smaller than the diameter R4 of the monochrome transfer roller 51 and the diameters R5, R6 and R7 of the color transfer rollers 21A, 31A and 41A become gradually smaller as they move a farther distance from the fixing shaft 64. Thus, this exemplary embodiment requires a larger stroke than that of the previous exemplary embodiment to move the color transfer rollers 21A, 31A and 41A nearer or farther away from the color latent image carrying members 20, 30 and 40.

In other words, as shown in FIG. 6, when the cam 63 is shifted from the double-dotted line location to the solid line location against the biased force of the resilient biased spring 62, since the diameter R5 of the color transfer roller 21A located farthest from the fixing shaft 64 is the smallest one and the diameter R6 of the color transfer roller 31A is secondly small, there is a large stroke when the roller supporting plate 61 is moved close to or spaced away from the transfer belt 10.

The distance that the roller supporting plate 61 moves between the double-dotted line location and the solid line location can be made large and the roller supporting plate 61 presses the color transfer rollers 21A, 31A and 41A to the transfer belt 10 with adequate pressure so a desired image without hollow defects can be formed. Also, the pivot angle required to move the color transfer rollers 21A, 31A and 41A away from the transfer belt 10 is small compared to the conventional art as shown in FIG. 7 so that the image forming apparatus can be made more compact.

It will be understood that the present invention is not limited to the exemplary embodiment described in the above and it can be varied from the scope of the invention without departing the spirit of the invention. For example, in the respective exemplary embodiment of the roller supporting unit 60 described above, the end 61a of the roller supporting plate 61 is located at the downstream area of the rotating direction D for the transfer belt 10 and is axially supported by the fixing shaft 64 which has an axis substantially perpendicular to the main rotating direction of D. However, the supporting location of the fixing shaft 64 is not limited to this configuration, and it can be located at the other end 61b of the plate (that is, at the upstream area of the rotating direction D). The roller supporting plate 61 may be supported in other manners. However, when the roller supporting 61 is supported by the fixing shaft 64, the movement of the color transfer rollers 21, 31 and 41 towards or away from the color latent image carrying members 20, 30 and 40 is stable.

Furthermore, in the above exemplary embodiment, the first color latent image carrying member 20 forms a yellow color image and the second color latent image carrying member 30 forms a magenta color image and the third color latent image carrying member 40 forms a cyan color image. However, the present invention is not limited to this particular configuration, and the number and colors of the color latent image carrying members may be varied. Also, the location of the mono color latent carrying member may be changed from the upstream area of the rotating direction D for the transfer belt 10 and the other end of the arrangement of the color latent image carrying members 20, 30 and 40.

The image forming apparatus of the exemplary embodiments of the present invention is a tandem type color image forming apparatus which can produce a high quality of transferred image and can be compact. The transfer rollers are not pressed to the transfer belt with too much force, so hollow defects can be prevented.

According to the exemplary embodiments of the invention, either end of the roller supporting plate may be pivotally supported by the fixing shaft (at either the upstream or downstream area of the transfer belt) so that the movement of the color transfer roller is stable.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming apparatus comprising:
a transfer belt in which a toner image is transferred;
a plurality of color latent image carrying members arranged successively along the transfer belt to form color toner images;
a monochrome latent image carrying member located at an end of the plurality of color latent image carrying members to form a monochrome toner image;
a monochrome transfer roller arranged opposite to the monochrome image carrying member with the transfer belt therebetween;
a plurality of color transfer rollers arranged opposite to the color image carrying members with the transfer belt therebetween, the diameters of the color transfer rollers being smaller than the diameter of the monochrome transfer roller;
a roller supporting member supporting the plurality of color transfer rollers; and
a roller shifting unit that moves the roller supporting member in a direction in which the color transfer rollers move toward or away from the color latent image carrying members.

2. The image forming apparatus of claim 1, wherein one of an upstream end or a downstream end of the roller supporting member is pivotally supported by a fixing shaft.

3. The image forming apparatus of claim 2, wherein the diameters of the color transfer rollers become smaller as the color transfer rollers become more distant from the fixing shaft.

4. The image forming apparatus of claim 1, wherein the roller shifting unit comprises:
a resilient biased member for biasing the roller supporting member away from the color latent image carrying members; and
a shifting member for moving the roller supporting member to be close to the color latent image carrying members against the force of the resilient biased member.

5. The image forming apparatus of claim 4, wherein the shifting member is a cam which contacts the roller supporting member and has an outer peripheral edge which is a variable distance from a rotating shaft of the cam.

6. The image forming apparatus of claim 1, wherein the plurality of the color transfer rollers are attached to the roller supporting member through adjusting springs.

7. An image forming apparatus comprising:
a transfer belt for receiving toner images;
a plurality of color latent image carrying members for forming color toner images, the color latent image carrying members being arranged successively along the transfer belt;
a monochrome latent image carrying member for forming monochrome toner images, the monochrome latent image carrying member being located at one end of the plurality of color latent image carrying members;
a monochrome transfer roller arranged opposite to the monochrome image carrying member, the transfer belt passing between the monochrome transfer roller and the monochrome image carrying member;
a plurality of color transfer rollers arranged opposite to the plurality of color image carrying members, the transfer belt passing between the plurality of color transfer rollers and the plurality of color image carrying members, the diameters of the color transfer rollers being smaller than the diameter of the monochrome transfer roller;
a roller supporting member that supports the plurality of color transfer rollers; and
a roller shifting unit for moving the roller supporting member in a direction in which the color transfer rollers move toward or away from the color latent image carrying members.

8. The image forming apparatus of claim 7, further comprising a fixing shaft for pivotally supporting one end of the roller supporting member.

9. The image forming apparatus of claim 8, wherein the diameters of the color transfer rollers are substantially equal.

10. The image forming apparatus of claim 9, wherein the diameters of the color transfer rollers are different.

11. The image forming apparatus of claim 10, wherein the diameters of the color transfer rollers become smaller as the color transfer rollers become more distant from the fixing shaft.

12. The image forming apparatus of claim 7, wherein the roller shifting unit comprises:
a resilient biased member for biasing the roller supporting member away from the color latent image carrying members; and
a shifting member for moving the roller supporting member towards the color latent image carrying members.

13. The image forming apparatus of claim 12, wherein the shifting member is a cam which contacts the roller supporting member.

14. The image forming apparatus of claim 7, wherein the plurality of the color transfer rollers are attached to the roller supporting member by adjusting springs.

15. An image forming apparatus comprising:
a transfer belt for receiving toner images;
a plurality of color latent image carrying members for forming color toner images, the color latent image carrying members being arranged successively along the transfer belt;
a monochrome latent image carrying member for forming monochrome toner images, the monochrome latent image carrying member being located at one end of the plurality of color latent image carrying members;
a monochrome transfer roller arranged opposite to the monochrome image carrying member, the transfer belt passing between the monochrome transfer roller and the monochrome image carrying member;
a plurality of color transfer rollers arranged opposite to the plurality of color image carrying members, the transfer belt passing between the plurality of color transfer rollers and the plurality of color image carrying members, the diameters of the color transfer rollers being smaller than the diameter of the monochrome transfer roller;
means for supporting the plurality of color transfer rollers; and
means for moving the means for supporting the color transfer rollers toward or away from the color latent image carrying members.

16. The image forming apparatus of claim 15, wherein the means for supporting the plurality of color transfer rollers comprises a pivotable plate member.

17. The image forming apparatus of claim 16, wherein the diameters of the color transfer rollers become smaller as the color transfer rollers become more distant from a pivoting axis of the pivotable plate member.

18. The image forming apparatus of claim 16, wherein the moving means comprises a cam that contacts the pivotable plate member.

19. The image forming apparatus of claim 18, further comprising means for biasing the pivotable plate member away from the color latent image carrying members.

20. The image forming apparatus of claim 15, wherein the diameters of the color transfer rollers are substantially equal.

21. The image forming apparatus of claim 15, wherein the diameters of the color transfer rollers are different.

22. An apparatus for adjusting a transfer roller in an image forming apparatus having a monochrome latent image carrying member and a monochrome transfer roller arranged opposite to the monochrome image carrying member and at least one color latent image carrying member and at least one color transfer roller arranged opposite to the color latent image carrying member, the apparatus comprising:
a roller supporting member supporting the at least one color transfer roller; and
a roller shifting unit to move the roller supporting member toward or away from the color latent image carrying member,
wherein the color transfer roller has a smaller diameter than the monochrome transfer roller.

23. The apparatus for adjusting a transfer roller of claim 22, wherein the roller supporting member is pivotally supported by a fixing shaft.

24. The apparatus for adjusting a transfer roller of claim 22, further comprising a plurality of color latent image carrying members and a plurality of corresponding color transfer rollers disposed on the roller supporting member.

25. The apparatus for adjusting a transfer roller of claim 24, wherein the diameters of the plurality of color transfer rollers are substantially equal.

26. The apparatus for adjusting a transfer roller of claim 24, wherein the diameters of the plurality of color transfer rollers are different.

27. The apparatus for adjusting a transfer roller of claim 22, wherein the roller shifting unit comprises:
a resilient member for biasing the roller supporting member away from the at least one color latent image carrying member; and
a shifting member for moving the roller supporting member closer to the at least one color latent image carrying member against the force of the resilient member.

28. The apparatus for adjusting a transfer roller of claim 27, wherein the shifting member is a cam that contacts the roller supporting member.

29. An image forming apparatus, comprising:
a first latent image carrying member;
a first transfer roller disposed opposite to the first image carrying member;
a second latent image carrying member;
a second transfer roller disposed opposite to the second latent image carrying member, the second transfer roller having a smaller diameter than the first transfer roller;
means for moving the second transfer roller toward or away from the second latent image carrying member.

30. The image forming apparatus of claim 29, wherein the means for moving the second transfer roller comprises:
a pivotable roller supporting member that supports the second transfer roller; and
a roller shifting unit to move the roller supporting member toward or away from the second latent image carrying member.

31. The image forming apparatus of claim 30, further comprising:
a third latent image carrying member;
a third transfer roller disposed opposite to the third latent image carrying member, the third transfer roller being supported by the pivotable roller supporting member.

32. The image forming apparatus of claim 31, wherein a diameter of the third transfer roller is the same as the diameter of the second transfer roller.

33. The image forming apparatus of claim 31, wherein a diameter of the third transfer roller is different than the diameter the second transfer roller.

34. The image forming apparatus of claim 30, wherein the roller shifting unit comprises:
a resilient member for biasing the roller supporting member away from the second latent image carrying member; and
a shifting member for moving the roller supporting member closer to the second latent image carrying member against the force of the resilient member.

35. The image forming apparatus of claim 34, wherein the shifting member is a cam that contacts the roller supporting member.
